(19) United States
(12) Patent Application Publication
(10) Pub. No.: US 2003/0124210 A1
(43) Pub. Date: Jul. 3, 2003

(54) Injection machine of hierarchical structure type

(75) Inventors: Fumiyuki Kato, Shizuoka-Ken (JP); Tatsuhiko Maru, Shizuoka-Ken (JP); Jun Koike, Shizuoka-Ken (JP); Makoto Nishizawa, Numazu-Shi (JP)

Correspondence Address: PILLSBURY WINTHROP, LLP, P.O. BOX 10500, MCLEAN, VA, 22102, US

(73) Assignee: TOSHIBA KIKAI KABUSHIKI KAISHA, Tokyo-To (JP)

(21) Appl. No.: 10/329,226

(22) Filed: Dec. 27, 2002

(30) Foreign Application Priority Data
Dec. 27, 2001 (JP) 2001-396152

(51) Int. Cl. B29C 45/76

(52) U.S. Cl. 425/145

(57) ABSTRACT

An injection machine of a hierarchical structure type according to the present invention includes a rest having a plurality of floors, a first injection molder mounted on a first floor of the rest, and a second injection molder mounted on a second floor of the rest. The first injection molder and the second injection molder are controlled by an integrated control board. A set display device is provided which is capable of transmitting data of the first and second injection molders between the set display device and the integrated control board in order to set or display the data.

### BACKGROUND OF THE INVENTION

1. Field of the Invention

The present invention relates to an injection machine of a hierarchical structure type which has a plurality of injection molders respectively mounted on each floor of a hierarchically structured rest.

2. Description of Related Art

In order to obtain a downsized injection machine to reduce a floor area needed for a placement thereof, an injection machine of a hierarchical structure type is conventionally known with a hierarchical structure shown in FIG. 3.

In the injection machine of a hierarchical structure type 140 shown in FIG. 3, a first injection molder 110 having a clamping device 112 and an injector 114 is mounted on an uppermost floor of two rests 111 and 131, which provide four floors in total. A first set display device 113 is provided on the first injection molder 110, for setting and displaying data of the first injection molder 110. A control board 115 for controlling the first injection molder 110 is mounted on a floor which is immediately under the uppermost floor 111.

A second injection molder 130 which has a clamping device 132 and an injector 134, is mounted on a third floor from the top. A second set display device 133 is provided on the second injection molder 130, for setting and displaying data of the second injection molder 130. A control board 135 for controlling the second injection molder 130 is mounted on the lowermost floor.

As shown in FIG. 4A, the control board 115 has a first and a second servo amplifiers 161 and 162 for respectively driving a first and a second servo motors 165 and 166. The control board 115 also has a first controller 160 for controlling the servo amplifiers 161 and 162, as well as a first I/O, a first sensor input, a first heater, and a first geared motor, which are indicated by a reference number 168. The first controller 160 is connected to a first power supply circuit 171.

The first set display device 113 is connected to the first controller 160. Thus, the first set display device 113 is capable of sending and receiving one or more signals to and from the first controller 160 in order to set and display various data of the first injection molder 110.

In a substantially similar fashion, as shown in FIG. 4B, the control board 135 has a third and a fourth servo amplifiers 181 and 182 for respectively driving a third and a fourth servo motors 185 and 186. The control board 135 also has a second controller 180 for controlling the servo amplifiers 181 and 182, as well as a second I/O, a second sensor input, a second heater, and a second geared motor, which are indicated by a reference number 188. The second controller 180 is connected to a second power supply circuit 172.

The second set display device 133 is connected to the second controller 180. Thus, the second set display device 133 is capable of sending and receiving one or more signals to and from the second controller 180 in order to set and display various data of the second injection molder 130.

The respective control boards 115 and 135 containing the above controlling elements are rather large-scale, and are placed on separate floors. Thus, especially in terms of operationality, a height of the injection machine of a hierarchical structure type 140 shown in FIG. 3 is excessively raised, relative to a body height of an operator.

Accordingly, the injection machine of a hierarchical structure type 140 has a stage 121 which acts as a platform on which an operator operates the first set display device 113 and so on, and a ladder 122 by which the operator goes up to the stage 121. Further, safety bars 123 and 124 are provided for surrounding the stage 121 and the ladder 122, because an operation on the stage 121 is carried out on the elevated platform.

These days, it is common for a single operator to take charge of two or more injection molders, instead of one injection molder.

In this case, however, it is necessary for the operator to repeatedly walk up and down the ladder to check screens of the respective set display devices which are independently provided on the separate floors, or to ensure proper operations of the respective mechanical devices. This is time-consuming, as well as physically burdensome to the operator.

As compared to a flat-type structure (on a single floor), additional structures such as a stage and a safety bar are necessary, which results in raised costs. Further, a control board contains a number of parts therein, and a number of set display devices are present, which are factors that increase costs. Numerous parts in a control board cause the control board to be enlarged, and thus a height of the hierarchical structure is also increased, preventing a reduction of the placement area. Overall, such factors as described above are disadvantageous with respect to an operationality, a workability, and costs.

However, an assignment of one operator to each injection molder requires additional personnel costs.

### SUMMARY OF THE INVENTION

To solve the above disadvantages, an object of the present invention is to provide a downscaled injection machine of a hierarchical structure type which provides superior operationality and workability, while a placement area, an operation area, and costs thereof are reduced.

An injection machine of a hierarchical structure type according to the present invention includes a rest having a plurality of floors, a first injection molder mounted on a first floor of the rest, a second injection molder mounted on a second floor of the rest, an integrated control board that controls the first injection molder and the second injection molder, and a set display device capable of transmitting data of the first and second injection molders between the set display device and the integrated control board in order to set or display the data.

In the present invention, control boards, which are conventionally arranged on two separate floors, are integrated into a single integrated control board. Thus, as compared with a conventional one, a more downscaled injection machine of a hierarchical structure type can be realized.

Further, set display devices, which are conventionally needed according to the number of injection molders mounted on a rest, are also integrated into a single set display device, which is effective in operationality, workability, and cost cutting.

In the injection machine of a hierarchical structure type, the integrated control board may be mounted on the rest, or arranged independently from the rest. Similarly, the set display device may be mounted on the rest, or arranged independently from the rest.

When the set display device is mounted on the rest at a proper height, or is arranged independently from the rest at a proper height, it is possible for an operator to set and check various data of the respective injection molders, without walking up and down a ladder. Such a structure eliminates the need for a stage, which acts as a platform on which an operator operates, a ladder by which the operator goes up to the stage, and a safety bar for a safety operation on the elevated platform.

In the injection machine of a hierarchical structure type, the integrated control board may include a first controller for controlling the first injection molder and a second controller for controlling the second injection molder. In this case, it is preferable that the set display device be selectively connected to the first controller or the second controller. For example, the set display device may be selectively connected to the first controller or second controller by means of a connector or a switch.

In the injection machine of a hierarchical structure type, it is preferable that various data be wirelessly transmitted between the integrated control board and the set display device, which further improves operationality and workability.

### BRIEF DESCRIPTION OF THE DRAWINGS

FIG. 1 shows an injection machine of a hierarchical structure type having a first and a second injection molders, according to an embodiment of the present invention;

FIG. 2 is a block diagram showing an example of a constitution of control circuits which is included in an integrated control board of an injection machine of a hierarchical structure type according to an embodiment of the present invention;

FIG. 3 is a schematic view showing a constitution of a conventional injection machine of a hierarchical structure type;

FIG. 4A is a block diagram showing a constitution of control circuits which is included in a control board of a conventional injection machine of a hierarchical structure type; and

FIG. 4B is a block diagram showing a constitution of control circuits which is included in a control board of a conventional injection machine of a hierarchical structure type.

### DETAILED DESCRIPTION OF A PREFERRED EMBODIMENT OF THE INVENTION

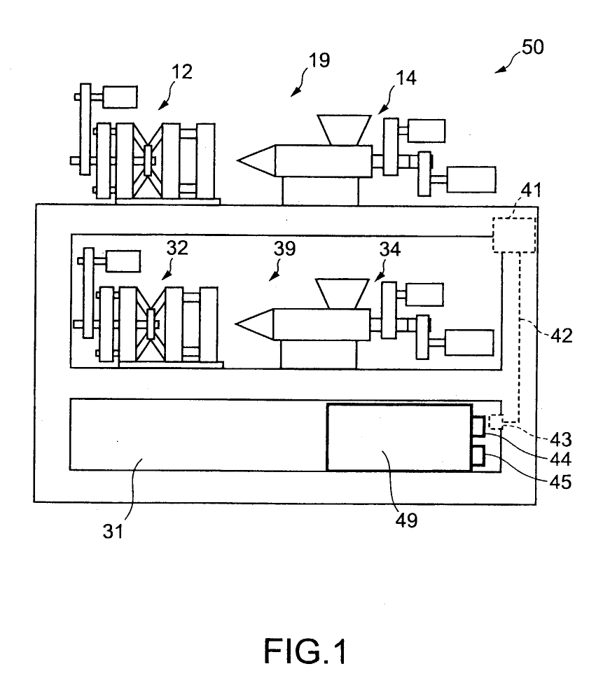

An embodiment of the present invention is described below with reference to FIG. 1.

FIG. 1 shows an injection machine of a hierarchical structure type 50. A first injection molder 19 having a clamping device 12 and an injector 14 is mounted on an uppermost floor of a rest 31 which provides three floors. A second injection molder 39 having a clamping device 32 and an injector 34 is mounted on a middle floor of the rest 31.

The injection machine of a hierarchical structure type 50 includes a set display device 41, which sets various data for operating the first injection molder 19 and various data for operating the second injection molder 39, and which also displays an operational condition of the first injection molder 19, an operational condition of the second injection molder 39, the various set data, and so on. The set display device 41 is connected to a connecting plug 43 through a cable 42. The connecting plug 43 is adapted to be attached to a connecting portion 44 or a connecting portion 45 which are provided on an integrated control board 49. Since the connecting plug 43 is detachable, the set display device 41 is easily moved or attached. FIG. 1 shows the set display device 41 placed on the rest 31. However, the set display device 41 may be separated from the rest 31 to be used independently. Further, it is even possible to attach the set display device 41 to an other injection machine of a hierarchical structure type.

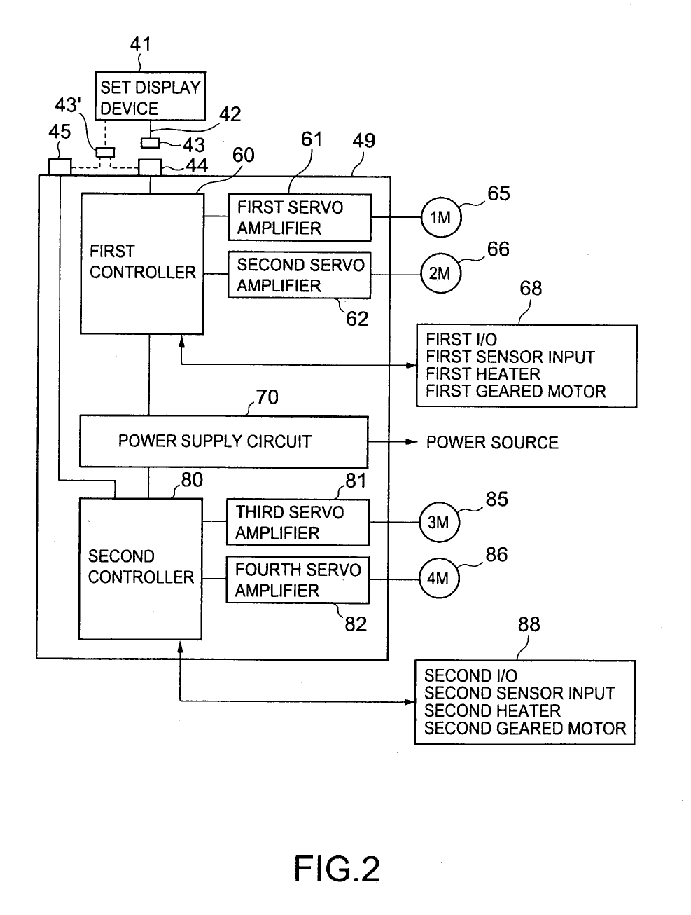

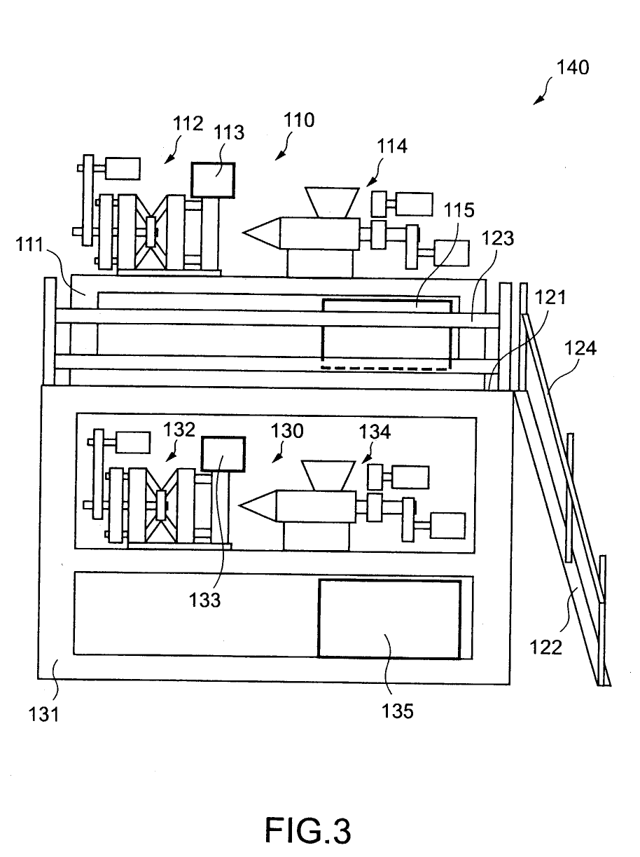

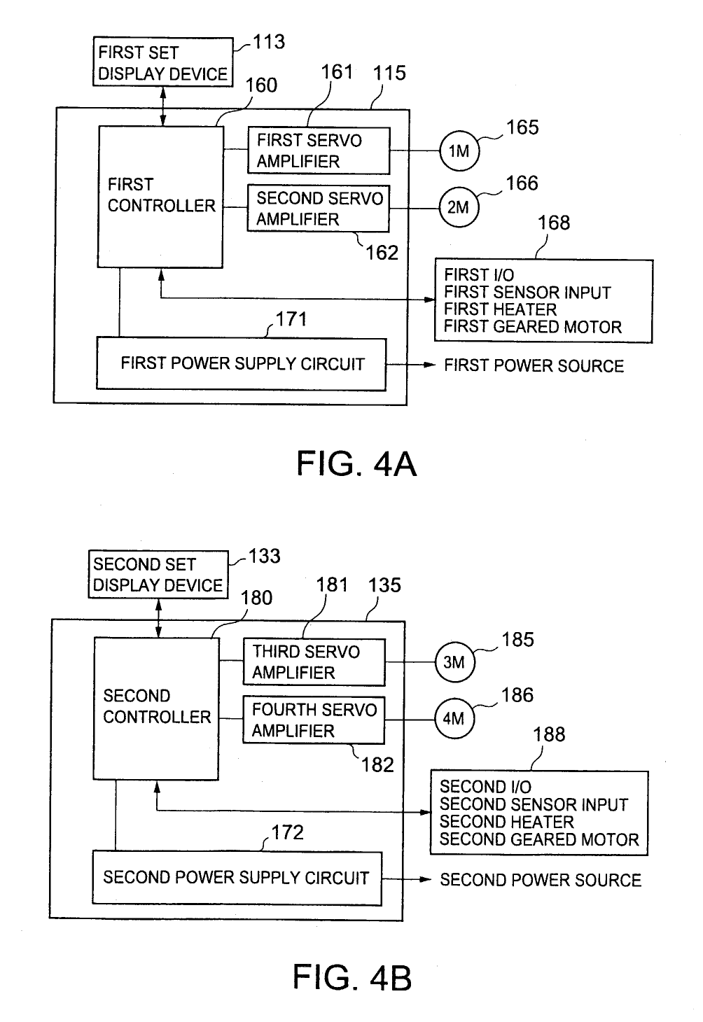

The integrated control board 49 having concentrated and integrated circuits is placed on a lowermost floor of the rest 31, which controls the first injection molder 19 and the second injection molder 39. As shown in FIG. 2, the integrated control board 49 contains a first controller 60 for controlling the first injection molder 19, a second controller 80 for controlling the second injection molder 39, first to fourth servo amplifiers 61, 62, 81, 82, and an integrated power supply circuit 70.

Although not shown, the first controller 60 and the second controller 80 respectively include a CPU (Central Processing Unit), an SU (Storage Unit), an I/O device, a programmable logic controller, and an interface for a set display device. As shown in FIG. 2, the respective first and second controllers 60 and 80 are connected to the power supply circuit 70.

The first controller 60 controls the first and the second servo amplifiers 61 and 62 for respectively driving servo motors 65 and 66, as well as a first I/O, a first sensor input, a first heater, and a first geared motor, which are indicated by a reference number 68.

Similarly, the second controller 80 controls a third and a fourth servo motors 81 and 82 for respectively driving servo amplifiers 85 and 86, as well as the second I/O, the second sensor input, a second heater, and a second geared motor, which are indicated by a reference number 88.

The first controller 60 or the second controller 80 send and receive one or more signals to and from the set display device 41 through the cable 42, the connecting plug 43, and the connecting portion 44 or 45. The set display device 41 sets various data for operating the first injection molder 19 and various data for operating the second injection molder 39, and displays an operational condition of the first injection molder 19, an operational condition of the second injection molder 39, the various set data, and so on.

The connecting plug 43 of the set display device 41 is capable of selectively being connected to the connecting portion 44 or the connecting portion 45, which are respectively connected to the first controller 60 and the second controller 80 as a control part incorporated in the integrated control board 49.

Instead of the connecting plug 43, the set display device 41 may be selectively, electrically connected to the first controller 60 or the second controller 80 by means of a switch 43′.

A signal transmission may be wirelessly carried out between the set display device 41 and the integrated control board 49. Light, sound (ultrasonic wave or voice), or radio waves may be used to wirelessly transmit signals.

In the above embodiment, only the power supply circuit 70 is integrated into a single one, but the first and the second controllers 60 and 80 may be integrated into a single controller, which allows the injection machine of a hierarchical structure type to be further downsized (to be compact).

The present invention has been described in terms of an injection machine of a hierarchical structure type which has a single injection molder mounted on each floor. However, a rest may be horizontally extended to increase the number of injection molders mounted on each floor. For example, the present invention is applicable to an injection machine of a hierarchical structure type which has adjacent or opposed injection molders mounted on each floor. Such a constitution further saves space, because operation areas for the adjacent or opposed injection molders are overlapped with each other.

For an injection machine of a hierarchical structure type having the increased number of injection molders, it is preferable to concentrate and integrate control parts of the respective injection molders into a single integrated control board.

When automatization, miniaturization, and data setting at a single location are possible, the present invention is applicable to an injection machine of a hierarchical structure type in which the number of floors is increased to have three or more injection molders in a tier-like manner.

Instead of placing an integrated control board on a lowermost floor of a rest, it may be placed on a rest at its side surface or an upper floor thereof. If a floor for placing the integrated control board becomes unnecessary,

a more downscaled injection machine of a hierarchical structure type can be realized.

Further, an integrated control board may be placed independently from a rest. Also in this case, a downscaled injection machine of a hierarchical structure type may be provided.

As described above, a set display device may be selectively connected to each controller by means of a connector in a physical fashion, or by means of a switch in an electrical fashion. Various data of the respective injection molders may be wirelessly transmitted between a set display device and an integrated control board. In all cases, a set display device is mounted on a rest, or arranged independently from a rest at a proper height. Thus, an operator is not required to walk up and down stages for operation, which results in improved operationality and workability.

An integrated control board has concentrated and integrated electric power sources and control parts which are contained in a single box. Thus, the integrated control board can be made extremely compact. When a control board mounted on a rest along with an injection molder is installed or moved, it is unnecessary for a number of electric wires to be attached to and detached from a terminal base.

What is claimed is:

1. An injection machine of a hierarchical structure type comprising:
a rest having a plurality of floors;
a first injection molder mounted on a first floor of the rest;
a second injection molder mounted on a second floor of the rest;
an integrated control board that controls the first injection molder and the second injection molder; and
a set display device capable of transmitting data of the first and second injection molders between the set display device and the integrated control board in order to set or display the data.

2. An injection machine of a hierarchical structure type according to claim 1, wherein
the integrated control board is mounted on the rest.

3. An injection machine of a hierarchical structure type according to claim 1, wherein
the integrated control board is arranged independently from the rest.

4. An injection machine of a hierarchical structure type according to claim 1, wherein
the set display device is mounted on the rest.

5. An injection machine of a hierarchical structure type according to claim 1, wherein
the set display device is arranged independently from the rest.

6. An injection machine of a hierarchical structure type according to claim 1, wherein
the integrated control board includes a first controller for controlling the first injection molder and a second controller for controlling the second injection molder, the set display device being selectively connected to the first controller or the second controller.

7. An injection machine of a hierarchical structure type according to claim 6, wherein
the set display device is selectively connected to the first controller or the second controller by means of a connector.

8. An injection machine of a hierarchical structure type according to claim 6, wherein
the set display device is selectively connected to the first controller or the second controller by means of a switch.

9. An injection machine of a hierarchical structure type according to claim 1, wherein
the data can be wirelessly transmitted between the integrated control board and the set display device.
